(19) United States
(12) Patent Application Publication
(10) Pub. No.: US 2006/0077574 A1
(43) Pub. Date: Apr. 13, 2006

(54) Lens body tube

(75) Inventor: Masashi Takahashi, Saitama-ken (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 11/242,831

(22) Filed: Oct. 5, 2005

(30) Foreign Application Priority Data
Oct. 7, 2004 (JP) 2004-294507

(51) Int. Cl. G02B 7/02

(52) U.S. Cl. 359/819

(57) ABSTRACT

A lens body tube including at least one component to be fixed therein is provided with at least one first recessed portion, each of which is recessed outward along the radial direction of the lens body tube on a part of the inner circumferential surface of the lens body tube, at least one second recessed portion, each of which is recessed inward along the radial direction of the lens body tube on a part of the outer circumferential surface of a corresponding one of the at least one component which is located such that the outer circumferential surface thereof faces the inner circumferential surface of the lens body tube, and at least one insertion member. Each pair of the at least one first recessed portion and the at least one second recessed portion forms an opening recessed along the axial direction of the lens body tube. A corresponding one of the at least one insertion member is inserted into the opening along the axial direction of the lens body tube.

### BACKGROUND OF THE INVENTION

The present invention relates to a lens body tube in which components such as a lens and an aperture diaphragm are incorporated, and especially relates to a lens body tube capable of adjusting angular positions of the components incorporated therein with respect to the axis of the lens body tube.

A lens body tube provided in an optical apparatus such as a camera is configured with components such as at least one lens and an aperture diaphragm being incorporated therein. Such a lens body tube, for example, as disclosed in Japanese Unexamined Patent Publication No. 2004-191558, generally has a structure configured such that lens frames supporting lenses are fixed to a main body tube with screws. Japanese Unexamined Patent Publication No. 2004-191558 discloses the following structure of a lens body tube. A fixed lens that is not moved during a zooming operation is fixed to a body tube or a lens frame, and the body tube or the lens frame is fixed to an outside body tube thereof with screws. FIG. 1, which shows an example of such a lens body tube as provided with a fixed lens frame therein, is a half cross-sectional view of the lens body tube along an optical axis of the lens body tube, the lens body tube being an object to which the present invention will be applied. It is noted that the optical axis is indicated by a horizontal dashed line in FIG. 1. In this case, the lens body tube is configured as a zoom lens, and is provided with a cylindrical main body tube 1, a zoom ring 2 that is manually rotatably attached to the outer circumferential surface of the main body tube 1, and a cam tube 3 that is located on the inner circumferential surface of the main body tube 1 and is rotatable integrally with the above zoom ring 2. A first lens frame 41 is attached to the inner circumferential surface at the distal end of the main body tube 1. A second lens frame 51 and a third lens frame 61 are attached to the inner circumferential surface of the above-mentioned cam tube 3. The first, second, and third lens frames 41, 51, and 61 support a first lens 4, a second lens 5, and a third lens 6, respectively. The aforementioned first and second lens frames 41 and 51 are supported such that they can move along the optical axis inside the main body tube 1 according to rotation of the cam tube 3. In other words, the cam tube 3 is formed with two cam grooves (which are not shown in FIG. 1), and cam protrusions 42 and 52, which are integrally formed with the first and second lens frames 4 and 5, respectively, are inserted into the respective cam grooves. When the cam tube 3 is rotated, the first and second lens frames 41 and 51 are translated along the optical axis direction of the lens body tube due to engagement of the cam protrusions 42 and 52 with the respective cam grooves. It is noted that the optical axis direction is defined as a direction from the left side to the right side along the optical axis in FIG. 1.

On the other hand, the third lens frame 61 is fixed to the aforementioned main body tube 1. FIG. 7 is an enlarged cross-sectional view showing a conventional structure for fixing the third lens frame 61A to the main body tube 1A, and corresponds to a cross-sectional view along an A-A line shown in FIG. 1. The third lens frame 61A is integrally provided with an aperture diaphragm driving portion 7, which has to be located at a predetermined angular position with respect to the axis of the main body tube 1A, i.e., the optical axis of the lens body tube. Therefore, when the third lens frame 61A is fixed to the main body tube 1A inside the main body tube 1A, the angular position of the third lens frame 61A with respect to the axis of the main body tube 1A has to be determined. In order to fix the third lens frame 61A to the main body tube 1A in a state of the third lens frame 61A being located at a predetermined angular position in this way, in the constitution shown in FIG. 7, the third lens 61A is attached to the main body tube 1A such that the outer circumferential surface thereof has contact with the inner circumferential surface of the main body tube 1A. The main body tube 1A is formed with a screw hole 101 that penetrates through the main body tube 1A in the radial direction, and a screw 102 is inserted into the screw hole 101 to pass completely through the main body tube 1A. The third lens frame 61A is fixed to the main body tube 1A with the screw 102 being tightened in the third lens frame 61A.

In the case of the fixing structure of the third lens frame 61A shown in FIG. 7, when fastening the screw 102 to fix the third lens frame 61A, a fastening force of the screw 102 is applied to the main body tube 1A. Consequently, the main body tube 1A is likely to be partially deformed, so that the cam tube 3, which is connected to the outer circumferential surface of the main body tube 1A, cannot smoothly rotate. In addition, there is a problem that grease with which the cam tube 3 is lubricated, as indicated by a thick arrow in FIG. 7, leaks inside the main body tube 1A via a joint portion between the screw hole 101 and the third lens frame 61A, and thereby, the grease adheres to a lens surface and/or comes to the aperture diaphragm driving portion 7 to contaminate them. Especially, since it is necessary to fix the third lens frame 61A with screws at a plurality of positions in the circumferential direction in order to fix the third lens frame 61A stably, the grease is easier to leak as the number of the screws increases. Moreover, it is hard to downsize the main body tube 1A or the lens body tube, since it is necessary to use the screw 102 with a certain level of strength, i.e., the screw 102 that has a required length and a required diameter, in order to keep the angular position of the third lens frame 61A with respect to the axis of the main body tube 1A.

### SUMMARY OF THE INVENTION

The present invention is advantageous in that a lens body tube, which is capable of fixing parts such as lenses inside a body tube at a predetermined angular position without a screw hole being opened in a radial direction through the body tube, is provided.

According to an aspect of the invention, there is provided a lens body tube including at least one component to be fixed therein that is provided with at least one first recessed portion, each of which is recessed outward along the radial direction of the lens body tube on a part of the inner circumferential surface of the lens body tube, the at least one first recessed portion being arranged in the circumferential direction of the lens body tube, at least one second recessed portion, each of which is recessed inward along the radial direction of the lens body tube on a part of the outer circumferential surface of a corresponding one of the at least one component which is located such that the outer circumferential surface thereof faces the inner circumferential surface of the lens body tube, the at least one second recessed portion being arranged in the circumferential direction of the lens body tube, and at least one insertion member. Each pair of the at least one first recessed portion and the at least one second recessed portion forms an opening recessed along the axial direction of the lens body tube. A corresponding one of the at least one insertion member is inserted into the opening along the axial direction of the lens body tube.

Optionally, the lens body tube may further include at least one ring member, each of which is configured to be attached to the inner circumferential surface of the lens body tube to grip a corresponding one of the at least one component in the axial direction of the lens body tube inside the lens body tube.

Further optionally, the lens body tube may have a female screw portion on the inner circumferential surface thereof. Optionally, each of the at least one ring member may be configured to be screwed together with the female screw portion on the inner circumferential surface of the lens body tube.

Optionally, each of the at least one ring member may be configured to have contact with a corresponding one of the at least one insertion member in the axial direction of the lens body tube to prevent the one of the at least one insertion member from dropping out of the opening into which the one of the at least one insertion member is inserted.

Optionally, each of the at least one insertion member may be configured to be fastened to the lens body tube along the axial direction of the lens body tube.

Still optionally, each of the at least one insertion member may have a screw portion on the bottom face thereof to be screwed together with the lens body tube along the axial direction of the lens body tube.

Optionally, each of the at least one first recessed portion may be formed to have substantially a semicircular cross section. In this case, each of the at least one second recessed portion may be formed to have substantially a semicircular cross section. Thereby, each pair of the at least one first recessed portion and the at least one second recessed portion may form substantially a circular opening. Preferably, each of the at least one insertion member may be formed of substantially a cylinder solid.

Optionally, one of the at least one component may be a lens frame that is configured to support a lens and integrally include an aperture diaphragm driving portion.

### BRIEF DESCRIPTION OF THE ACCOMPANYING DRAWINGS

FIG. 1 is a half cross-sectional view of a lens body tube to which the present invention is applied, along an optical axis of the lens body tube;

FIG. 2 is an enlarged cross-sectional view of a relevant part of a lens body tube of a first embodiment;

FIGS. 3A and 3B are cross-sectional views of the lens body tube of the first embodiment along an A-A line shown in FIG. 1 and a B-B line shown in FIG. 2, respectively;

FIG. 4 is an exploded perspective view of a relevant part of the lens body tube of the first embodiment;

FIG. 5 is an enlarged cross-sectional view of a relevant part of a lens body tube of a second embodiment;

FIGS. 6A and 6B are cross-sectional views of the lens body tube of the second embodiment along the A-A line shown in FIG. 1 and a C-C line shown in FIG. 5, respectively; and

FIG. 7 is a cross-sectional view of a conventional lens body tube along the A-A line shown in FIG. 1.

### DETAILED DESCRIPTION OF THE EMBODIMENTS

### First Embodiment

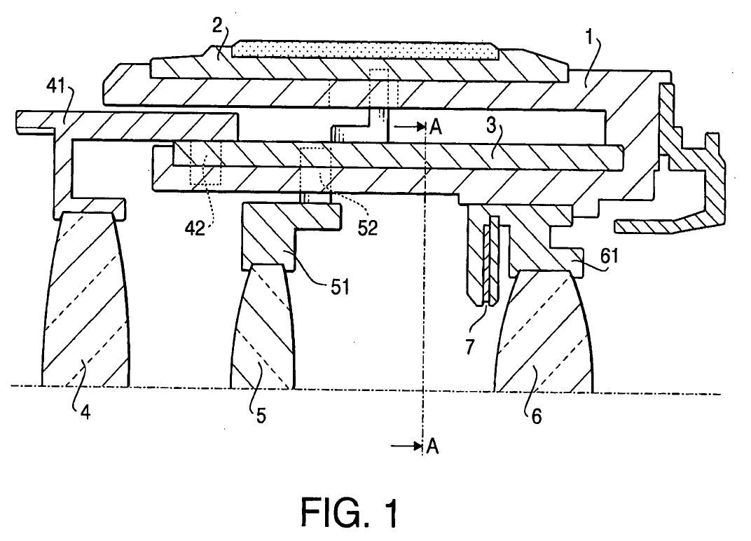

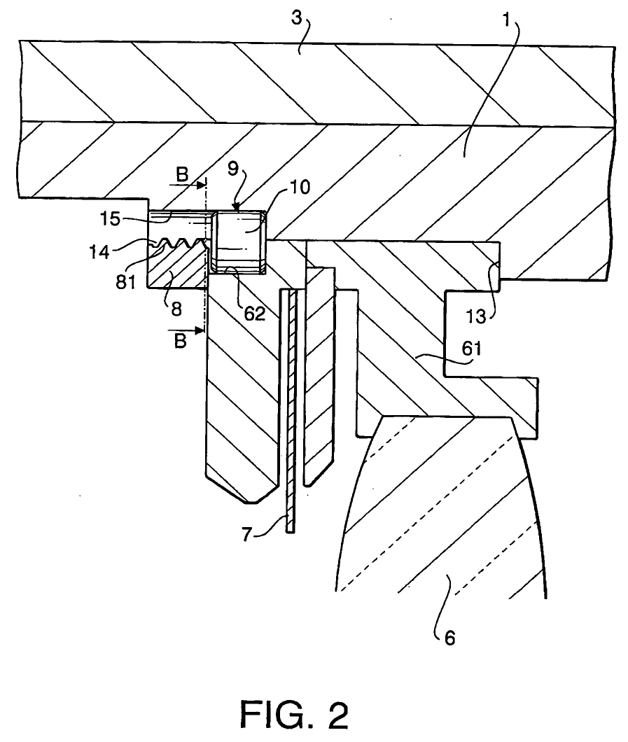

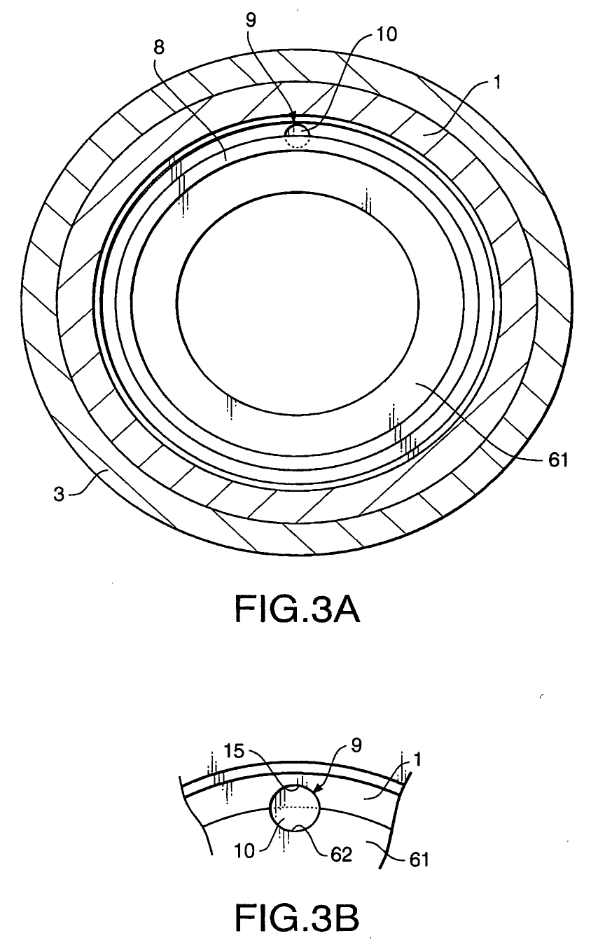

A first embodiment according to the present invention will be explained with reference to accompanying drawings. In the first embodiment, there will be shown an example where the present invention is applied to a structure for fixing a third lens frame 61, which supports a third lens 6, to a main body tube 1 in a lens body tube shown in FIG. 1. FIG. 2 is an enlarged cross-sectional view of a relevant part, and FIGS. 3A and 3B are cross-sectional views of the lens body tube along an A-A line shown in FIG. 1 and a B-B line shown in FIG. 2, respectively. The third lens frame 61 supports the third lens 6, and, at an adjacent position in an axial direction, is integrally provided with an aperture diaphragm driving portion 7 for driving a diaphragm. The aperture diaphragm driving portion 7, of which a detailed explanation will be omitted, drives the diaphragm provided in the third lens frame 61 to control an aperture, and is required to be located at a predetermined angular position with respect to the axis of the main body tube 1 so as to enable appropriate power distribution.

At a part on the inner circumferential surface of the main body tube 1, an annular step portion 13 is formed by making the inside diameters of an adjacent couple of parts different from one another, to one of which the third lens frame 61 is attached. A female screw portion 14 is formed at a place that is a required distance away from the step portion 13 in the axial direction of the main body tube 1. The third lens frame 61 is inserted into the main body tube 1 in the axial direction, and one end face, which is on the right side of the third lens frame 61 in FIG. 2, has contact with the step portion 13. In addition, the female screw portion 14 is screwed together with an annular locking ring 8 that has a male screw portion 81 on the outer circumferential surface thereof. The other end face, which is on the left side of the third lens frame 61 in FIG. 2, has contact with the locking ring 8. The third lens frame 61 is fixed inside the main body tube 1 with the third lens frame 61 being gripped between the locking ring 8 and the step portion 13 in the axial direction of the main body tube 1.

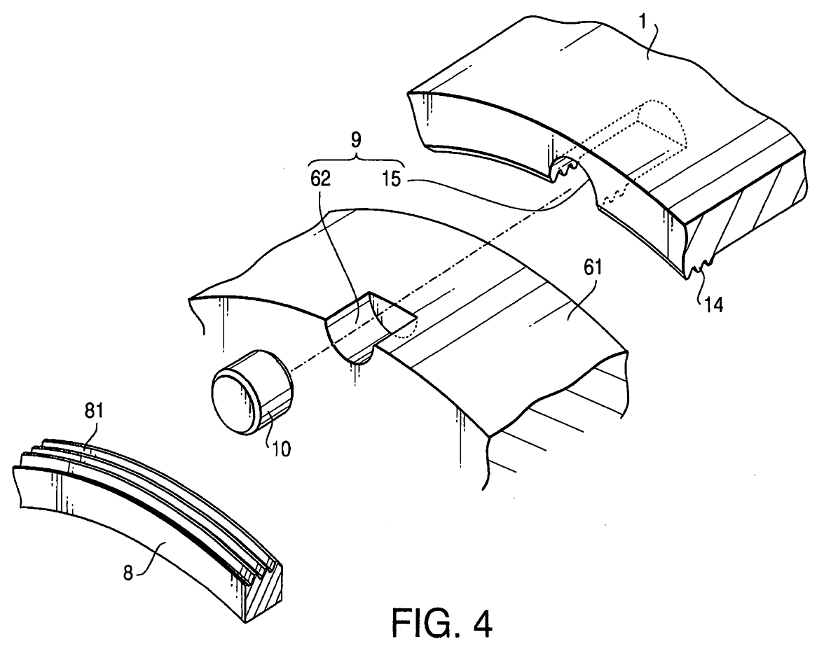

Moreover, as an exploded perspective view is schematically shown in FIG. 4, a location groove 62 that has a semicircular cross section with a predetermined diameter is formed on a portion of the outer circumferential surface of the third lens frame 61. On the other hand, a reference groove 15 that has a semicircular cross section with the same diameter as the location groove 62 is also formed on a portion of the inner circumferential surface of the main body tube 1. When the reference groove 15 and the location groove 62 are located at the same angular position with respect to the axis of the main body tube 1, both of the grooves are arranged opposite one another to form a circular recessed portion 9 between the main body tube 1 and the third lens frame 61. In the circular recessed portion 9, there is inserted a cylindrical circular pin 10 with substantially the same diameter and length in the optical axis direction of the lens body tube as the circular recessed portion 9. The circular pin 10 is inserted in a state where it has contact with each inner circumferential surface of the location groove 62 and the reference groove 15, and is fixed by the locking ring 8 such that the circular pin 10 does not drop out of the circular recessed portion 9. In such a way, by making the circular pin 10 have close contact with the inner circumferential surface of the circular recessed portion 9, backlash between the main body tube 1 and the third lens frame 61 in the circumferential direction and the optical axis direction can be restrained. In addition, the circular pin 10 may be configured to be slotted in the axial direction of the body tube such that the circular pin can deform in the radial direction and the outer circumferential surface thereof can have close contact with the inner circumferential surface of the circular recessed portion 9.

The assembling method of the third lens 6 in the lens body tube will be described as follows. The third lens frame 61, which previously supports the third lens 6 and is integrally provided with the aperture diaphragm driving portion 7, is inserted into the main body tube 1 from the distal end thereof, and one end face of the third lens frame 61 is made contact with the step portion 13. Next, rotating the third lens frame 61 around the axis of the main body tube 1, the angular position thereof is set such that the location groove 62 faces the reference groove 15 in the radial direction of the main body tube 1. The circular pin 10 is then inserted from the distal end of the main body tube 1 to be put in the circular recessed portion 9 that is configured with the location groove 62 and the reference groove 15. Thereby, the third lens frame 61 is locked in the rotation direction around the axis of the main body tube 1 with the circular pin 10 being in contact with the location groove 62 and the reference groove 15, and the angular position thereof is determined. The locking ring 8 is then inserted from the distal end of the main body tube 1, and the male screw portion 81 of the locking ring 8 is screwed together with the female screw portion 14 of the main body tube 1. Thereby, the locking ring 8 has contact with the other end face of the third lens frame 61 to grip the third lens frame 61 in the axial direction of the main body tube 1 between the step portion 13 and itself.

In this way, the angular position of the third lens frame 61 with respect to the axis of the main body tube 1 is determined with the circular pin 10 being inserted into the circular recessed portion 9 that is configured with the reference groove 15 on the inner circumferential surface of the main body tube 1 and the location groove 62 on the outer circumferential surface of the third lens frame 61. Further, the third lens frame 61 is fixed in the main body tube 1 with the locking ring 8 being tightened in the main body tube 1. Thereby, the third lens frame 61 is fixed inside the main body tube 1 by the circular pin 10 in a state where the angular position thereof with respect to the axis of the main body tube 1 is determined. In this case, since the circular pin 10 is in contact with the reference groove 15 and the location groove 62 in respect of the circular surface thereof, when a stress is applied to the circular pin 10 in the rotation direction around the axis of the main body tube 1, the stress is less likely to concentrate at a part of the contact surface, and the stable positioning of the third lens frame 61 is allowed.

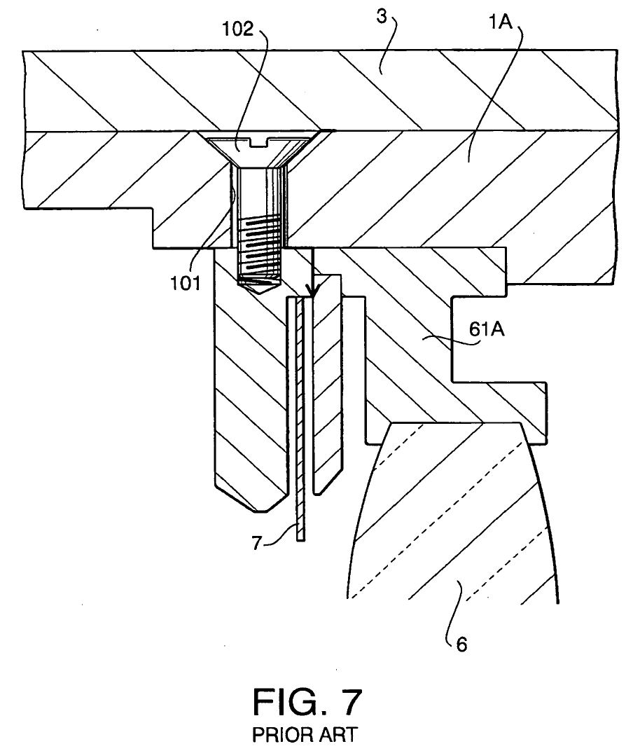

In addition, since a screw hole 101 is not required to be opened from the outer circumferential surface of a main body tube 1 to the inside thereof and to be screwed together with a screw 102, as a lens body tube shown in FIG. 7, the main body tube 1 is not deformed by the screw 102. Further, since grease with which a cam tube 3 is lubricated does not leak inside the main body tube 1 via the screw hole 101, the grease does not contaminate a lens and/or the aperture diaphragm driving portion 7. At the same time, since it is not necessary to use a screw with a predetermined length and diameter to determine the angular position of the third lens frame 61 with respect to the axis of the main body tube 1, the aforementioned features of this embodiment are advantageous in respect of downsizing the lens body tube. Moreover, in the constitution of this embodiment, since the locking ring 8 is attached to cover a part of the circular recessed portion 9, the locking ring 8 prevents the circular pin 10 inserted into the circular recessed portion 9 from dropping out, and the angular position of the third lens frame 61 can be stably maintained.

### Second Embodiment

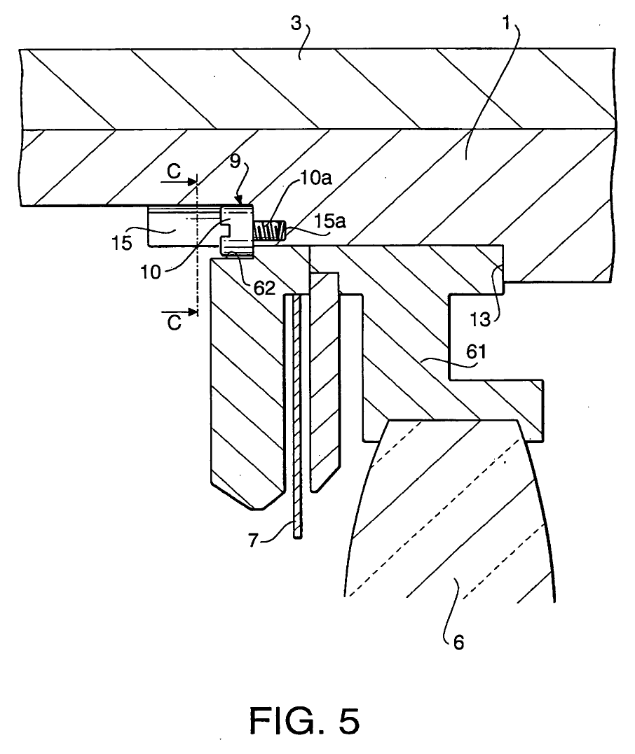

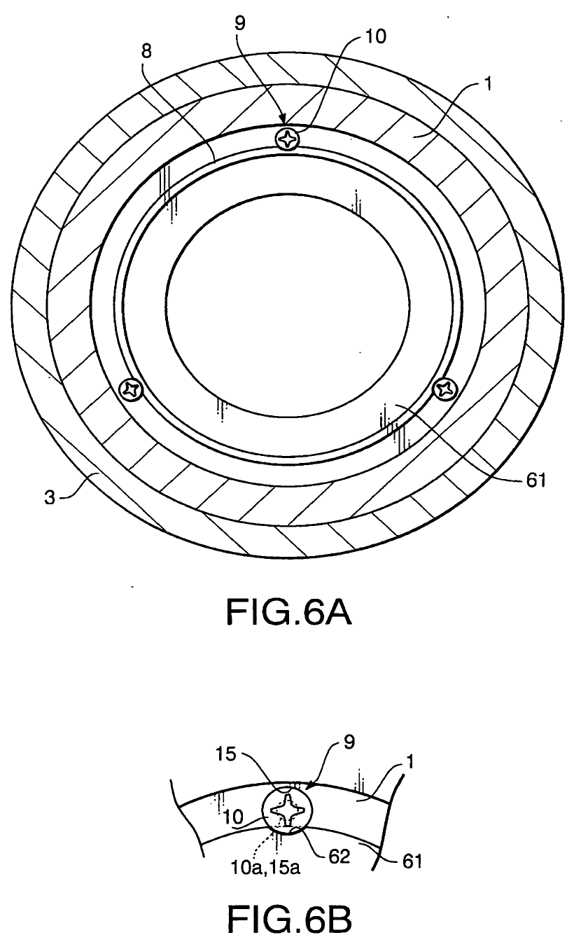

FIG. 5 shows a variation of a circular pin for determining the angular position of a third lens frame 61 with respect to the axis of a main body tube 1, and is an enlarged cross-sectional view of a relevant part of a lens body tube in a second embodiment in a similar fashion to FIG. 2 in the first embodiment. In addition, FIGS. 6A and 6B are cross-sectional views along the A-A line shown in FIG. 1 and a C-C line shown in FIG. 5, respectively. In the second embodiment, the circular pin has a function of fixing the third lens frame as well as the aforementioned function in the first embodiment, and each of equivalent parts to the first embodiment is labeled with the same reference number. A circular pin 10 is integrally formed with a small diameter screw 10a at the distal end thereof Further, corresponding to the circular pin 10 with the screw 10a, a reference groove 15 is formed of a circular arc with a large center angle on the inner circumferential surface, and is formed with a screw hole 15a to be screwed together with the screw 10a on an end face of the reference groove 15. On the other hand, a location groove 62 of the third lens frame 61 is formed of a circular arc with a small center angle. A pair of the location groove 62 and the reference groove 15 forms a circular recessed portion 9. Each of the reference groove 15 and the location groove 62 is formed at a plurality of places in the circumferential direction, in this case, at three places that are located at intervals of a center angle of 120 degrees. It is noted that in the second embodiment, a female screw portion is not formed as described in the first embodiment, and a locking ring is not employed.

In the second embodiment, the third lens frame 61 is inserted into the main body tube 1 until one end face of the third lens frame 61 has contact with a step portion 13. Rotating the third lens frame 61 around the axis of the main body tube 1, the angular position thereof is set such that the location groove 62 faces the reference groove 15, that is, a pair of the location groove 62 and the reference groove 15 forms the circular recessed portion 9. Then, the circular pin 10 is inserted into each of the circular recessed portions 9 that are formed at three places inside the main body tube 1. The screw 10a of the circular pins 10 is screwed together with the screw hole 15a, so that the circular pins 10 is fixed to the main body tube 1. Since the circular pin 10 is fixed to the main body tube 1 in this way, the bottom face of the circular pin 10 has contact with the bottom wall of the location groove 62, i.e., with the third lens frame 61, so that the third lens frame 61 is gripped in the axial direction of the main body tube 1 between the circular pin 10 and the step portion 13. In addition, the circumferential surface of the circular pin 10 has contact with each inner circumferential surface of the location groove 62 and the reference groove 15, so that the angular position of the third lens frame 61 with respect to the axis of the main body tube 1 in the similar fashion to the first embodiment. In this case, preferably, the length of the third lens frame 61 in the optical axis may be determined such that the bottom face of the location groove 62 is slightly protruded backward in the optical axis direction from the bottom face of the reference groove 15. Thereby, backlash of the third lens frame 61 in the optical axis direction can be restrained. Moreover, in the same way as the first embodiment, backlash thereof in the circumferential direction can be restrained if the circular pin 10 is designed such that the diameter thereof is substantially equal to the inside diameter of the circular recessed portion 10.

In the second embodiment as well as the first embodiment, since a screw hole is not required to be opened from the outer circumferential surface of a main body tube 1 to the inside thereof and to be screwed together with a screw, as a lens body tube shown in FIG. 7, the main body tube 1 is not deformed by the screw or the screw hole. Further, since grease with which a cam tube 3 is lubricated does not leak inside the main body tube 1 via the screw hole, the grease does not contaminate a lens and/or the aperture diaphragm driving portion 7. In addition, since it is unnecessary to prepare such a locking ring and a screw portion to be screwed together therewith as described in the first embodiment, the invention of the second embodiment is advantageous in simplifying the constitution of the main body tube.

Hereinabove, there are presented in the first and second embodiment the examples of the lens body tube in which the third lens is fixed inside the main body tube. It is noted that when an aperture diaphragm driving portion and/or other parts are fixed inside a main body tube independently of lenses, the present invention can be applied to the above portion and/or parts. In particular, if the present invention is applied to a part that is required to be fixed with the angular position thereof with respect to the optical axis of a lens body tube being specified, deformation of the main body tube and/or leakage of contaminated material such as external grease inside the main body tube are prevented.

The present invention can be applied to lens body tubes of various kinds of optical apparatuses, each of which is provided with lenses and/or various components being fixed in a body tube as well as a lens body tube of a camera.

The present disclosure relates to the subject matter contained in Japanese Patent Application No. P2004-294507, filed on Oct. 7, 2004, which is expressly incorporated herein by reference in its entirely.

What is claimed is:

1. A lens body tube including at least one component to be fixed therein, comprising:
at least one first recessed portion, each of which is recessed outward along the radial direction of the lens body tube on a part of the inner circumferential surface of the lens body tube, the at least one first recessed portion being arranged in the circumferential direction of the lens body tube;
at least one second recessed portion, each of which is recessed inward along the radial direction of the lens body tube on a part of the outer circumferential surface of a corresponding one of the at least one component which is located such that the outer circumferential surface thereof faces the inner circumferential surface of the lens body tube, the at least one second recessed portion being arranged in the circumferential direction of the lens body tube; and
at least one insertion member,
wherein each pair of the at least one first recessed portion and the at least one second recessed portion forms an opening recessed along the axial direction of the lens body tube, and
wherein a corresponding one of the at least one insertion member is inserted into the opening along the axial direction of the lens body tube.

2. The lens body tube according to claim 1, further comprising at least one ring member, each of which is configured to be attached to the inner circumferential surface of the lens body tube to grip a corresponding one of the at least one component in the axial direction of the lens body tube inside the lens body tube.

3. The lens body tube according to claim 2,
wherein the lens body tube has a female screw portion on the inner circumferential surface thereof, and
wherein each of the at least one ring member is configured to be screwed together with the female screw portion on the inner circumferential surface of the lens body tube.

4. The lens body tube according to claim 2,
wherein each of the at least one ring member is configured to have contact with a corresponding one of the at least one insertion member in the axial direction of the lens body tube to prevent the one of the at least one insertion member from dropping out of the opening into which the one of the at least one insertion member is inserted.

5. The lens body tube according to claim 3,
wherein each of the at least one ring member is configured to have contact with a corresponding one of the at least one insertion member in the axial direction of the lens body tube to prevent the one of the at least one insertion member from dropping out of the opening into which the one of the at least one insertion member is inserted.

6. The lens body tube according to claim 1,
wherein each of the at least one insertion member is configured to be fastened to the lens body tube along the axial direction of the lens body tube.

7. The lens body tube according to claim 6,
wherein each of the at least one insertion member has a screw portion on the bottom face thereof to be screwed together with the lens body tube along the axial direction of the lens body tube.

8. The lens body tube according to claim 1,
wherein each of the at least one first recessed portion is formed to have substantially a semicircular cross section,
wherein each of the at least one second recessed portion is formed to have substantially a semicircular cross section,
wherein each pair of the at least one first recessed portion and the at least one second recessed portion forms substantially a circular opening, and
wherein each of the at least one insertion member is formed of substantially a cylinder solid.

9. The lens body tube according to claim 6,
wherein each of the at least one first recessed portion is formed to have substantially a semicircular cross section,
wherein each of the at least one second recessed portion is formed to have substantially a semicircular cross section,
wherein each pair of the at least one first recessed portion and the at least one second recessed portion forms substantially a circular opening, and
wherein each of the at least one insertion member is formed of substantially a cylinder solid.

10. The lens body tube according to claim 7,
wherein each of the at least one first recessed portion is formed to have substantially a semicircular cross section,
wherein each of the at least one second recessed portion is formed to have substantially a semicircular cross section,
wherein each pair of the at least one first recessed portion and the at least one second recessed portion forms substantially a circular opening, and
wherein each of the at least one insertion member is formed of substantially a cylinder solid.

11. The lens body tube according to claim 1,
wherein one of the at least one component is a lens frame that is configured to support a lens and integrally include an aperture diaphragm driving portion.

12. The lens body tube according to claim 6,
wherein one of the at least one component is a lens frame that is configured to support a lens and integrally include an aperture diaphragm driving portion.

13. A lens body tube including at least one component to be fixed therein, comprising:
at least one first recessed portion, each of which is recessed outward along the radial direction of the lens body tube on a part of the inner circumferential surface of the lens body tube, the at least one first recessed portion being arranged in the circumferential direction of the lens body tube;
at least one second recessed portion, each of which is recessed inward along the radial direction of the lens body tube on a part of the outer circumferential surface of a corresponding one of the at least one component which is located such that the outer circumferential surface thereof faces the inner circumferential surface of the lens body tube, the at least one second recessed portion being arranged in the circumferential direction of the lens body tube;
at least one insertion member; and
at least one ring member, each of which is configured to be attached to the inner circumferential surface of the lens body tube to grip a corresponding one of the at least one component in the axial direction of the lens body tube inside the lens body tube,
wherein each of the at least one first recessed portion is formed to have substantially a semicircular cross section,
wherein each of the at least one second recessed portion is formed to have substantially a semicircular cross section,
wherein each pair of the at least one first recessed portion and the at least one second recessed portion forms substantially a circular opening recessed along the axial direction of the lens body tube,
wherein each of the at least one insertion member is formed of substantially a cylinder solid.
wherein a corresponding one of the at least one insertion member is inserted into the circular opening along the axial direction of the lens body tube,
wherein the lens body tube has a female screw portion on the inner circumferential surface thereof,
wherein each of the at least one ring member is configured to be screwed together with the female screw portion on the inner circumferential surface of the lens body tube, and
wherein each of the at least one ring member is configured to have contact with a corresponding one of the at least one insertion member in the axial direction of the lens body tube to prevent the one of the at least one insertion member from dropping out of the opening into which the one of the at least one insertion member is inserted.

14. The lens body tube according to claim 13,
wherein one of the at least one component is a lens frame that is configured to support a lens and integrally include an aperture diaphragm driving portion.
